(19) United States
(12) Patent Application Publication
(10) Pub. No.: US 2009/0076721 A1
(43) Pub. Date: Mar. 19, 2009

(54) NAVIGATION AID METHOD

(75) Inventors: Francois COULMEAU, Seilh (FR); Herve Goutelard, Juans-Les-Pains (FR); Jerome Sacle, Toulouse (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/208,460

(22) Filed: Sep. 11, 2008

(30) Foreign Application Priority Data
Sep. 14, 2007 (FR) 0706471

(51) Int. Cl. G01C 21/00

(52) U.S. Cl. 701/206

(57) ABSTRACT

The invention relates to a navigation aid method and device for an aircraft. The aircraft occupies a position PPOS outside its flight plan and seeks to rejoin the flight plan. The flight plan includes a succession of waypoints. A waypoint WPTᵢ is called sequenced once the aircraft has passed by the waypoint WPTᵢ at a lateral distance within the limits of the fixed sequencing conditions. The next unsequenced waypoint is called the active waypoint. The method includes the computation of at least one path to rejoin the flight plan from the current position PPOS, the computation of a potential active waypoint in the flight plan based on a rejoining path, the display of the potential active waypoint, if the pilot confirms the potential active waypoint, the sequencing of the waypoints situated upstream of the potential active waypoint, the said potential active waypoint becoming the new active waypoint.

### RELATED APPLICATIONS

The present application is based on, and claims priority from, French Application Number 0706471, filed Sep. 14, 2007, the disclosure of which is hereby incorporated by reference herein in its entirety.

### TECHNICAL FIELD

The invention relates to a navigation aid method for an aircraft and, more particularly, an aircraft flight plan sequencing method. The invention relates more specifically to a method for an aircraft to rejoin a flight plan defined in a flight management system of the aircraft from any point in space situated outside the flight plan.

### BACKGROUND OF THE INVENTION

The flight management computer (FMS) has, among other main functions: the generation and automatic following of a flight plan, a flight plan consisting of lateral and vertical paths that the aircraft must follow to go from the position that it occupies to its destination, and speeds of travelling these paths.

The generation of a flight plan is carried out among other things based on imposed waypoints associated with altitude and speed constraints. These imposed waypoints and their associated constraints are entered into the flight computer FMS by an operator of the aircraft, for example a member of the aircraft crew, by means of an item of equipment of the flight deck with a keyboard and screen providing the man-machine interface such as that known under the name MCDU, “Multipurpose Control and Display Unit”, or MFD, “Multipurpose Function Display”. The generation of the flight plan itself consists in constructing the lateral and vertical paths of the flight plan based on a sequence of “Legs”. The flight plan begins at a departure point, passes through imposed “Waypoints” and culminates at a point of arrival, while complying with standard rules of construction and taking account of altitude and speed constraints associated with each imposed waypoint. A leg is delimited by a departure waypoint and an arrival waypoint.

During navigation carried out under the management of the FMS (called “managed” navigation), the leg that the aircraft follows is the active leg. The arrival waypoint of the active leg is the active waypoint. The transition to the following leg is carried out by a sequencing of the waypoint terminating the active leg, according to travelling criteria (sequencing plan, distance relative to this waypoint, etc.). The following leg then becomes the active leg, and so on as the aircraft sequences the successive waypoints of the flight plan. An FMS also comprises a mode called “offset” making it possible to follow a path that is laterally offset from and parallel to the flight plan a certain distance away.

The sequencing action is necessary to obtain FMS guidance along the predicted path and a computation of predictions according to the route for rejoining the flight plan. In the design of certain FMSs, the sequencing of the flight plan is necessary to make it possible to fly the flight plan of the Missed Approach procedure or to return to the flight plan and continue navigation to another more distant point of the flight plan.

The aircraft sometimes leaves its flight plan due to a constraint, usually an air traffic control instruction. It must then rejoin its initial flight plan. In certain cases, the active waypoint is then behind the aircraft so that the automatic sequencing conditions of this waypoint are no longer achieved in particular because of the distance of the aircraft relative to this active waypoint.

According to the prior art, the sequencing of the flight plan is then carried out manually on the man-machine interface between the crew and the FMS, in several ways, for example by deleting the waypoints from the flight plan up to the desired point in front of the aircraft, by carrying out a manoeuvre of the “Direct” type to the desired point or by inserting the identifier of the desired waypoint instead of the previous active waypoint. These solutions have the disadvantage of requiring several buttons to be pressed, increasing the time allocated to this task. It is also a source of error potentially causing an incorrect sequencing of the flight plan which may cause a guidance of the aircraft that does not comply with the expected guidance. The sequencing action requires thought on the part of the crew and consequently requires a little time (finding the waypoint in a list that may contain up to 200 of them, managing the duplicates that are the points that have the same alphanumeric identifier but are located in different places). It is a source of error and may occur in the approach phase where the workload is greater. The sequencing of the flight plan is obligatory so that the computation of the predictions of the FMS and the associated guidance comply with the expectations of the crew, especially in the missed approach phase. A missed approach flight plan flown manually following the unsequenced flight plan requires mental resources in order to follow the corresponding path.

### SUMMARY OF THE INVENTION

The invention aims to alleviate the abovementioned problems by proposing a navigation aid method carrying out a semi-automatic flight plan sequencing in order to make it easier for an aircraft to rejoin the flight plan. The FMS anticipates the path for rejoining the flight plan and proposes that the pilot sequence the flight plan: finding the active point or “TO waypoint”, that is to say the point to which the system will head. The method according to the invention selects the best candidate from the potential “TO waypoints” of the flight plan. The pilot then confirms the sequencing or ignores the sequencing if it does not match his intention. When the pilot does not desire the sequencing, the active waypoint is not changed and the sequencing will be proposed again when the criteria for rejoining the flight plan are again reached.

The method according to the invention makes it possible to sequence the flight plan by showing the pilot the new active waypoint that is fully logical according to the adopted path. It does not automatically sequence the flight plan; the pilot keeps control preventing an incorrect automatic sequencing. It involves saving time by restricting the pilot's thinking about the application of the sequencing as is carried out according to the prior art. The method according to the invention makes it possible, following forgetting to sequence the flight plan before the final approach, to sequence it rapidly in order to be able to benefit from the availability of the missed approach flight plan in a managed path.

The method according to the invention operates in the navigation mode called HDG/TRK, the mode according to which the aircraft heads towards a heading given by air traffic control. The method according to the invention does not require the NAV mode (automatic navigation) to be engaged. The method produces a sequencing of the flight plan and a movement of the active point. The lateral active mode remains the HDG/TRK mode; the sequencing has no effect on the lateral guidance mode of the automatic pilot.

The method according to the invention relates to the sequencing of the flight plan in any flight phase of the aircraft, climb, cruise, descend, approach, missed approach according to a semi-automatic method proposed by the FMS and easily confirmed by the pilot if he wishes.

Accordingly, the subject of the invention is a navigation aid method for an aircraft, the aircraft occupying a position PPOS outside its flight plan and seeking to rejoin the flight plan, the flight plan comprising a succession of waypoints, a waypoint WPTᵢ being called sequenced once the aircraft has passed the waypoint WPTᵢ, the next unsequenced waypoint being called an active waypoint, the method comprises the following steps:
the computation of at least one path to rejoin the flight plan from the current position PPOS,

the computation of a potential active waypoint in the flight plan based on a rejoining path,

the display of the potential active waypoint,

if the pilot confirms the potential active waypoint, the sequencing of the waypoints situated upstream of the potential active waypoint, the potential active waypoint becoming the new active waypoint,

if the pilot does not confirm the potential active waypoint, the return to the step for computing at least one rejoining path and the proposal of a new potential active waypoint.

According to a variant of the method according to the invention, the method also comprises a step of computing the intersection between the path for rejoining the flight plan and the flight plan and in that the computed potential active waypoint is the first waypoint situated downstream of the intersection.

According to another variant of the method according to the invention, the step of computing at least one path for rejoining the flight plan comprises:
the selection of at least two unsequenced waypoints,
and, for each of these two waypoints:
   the computation of a path for rejoining the waypoint,
   the computation of predictions of at least one flight parameter,

and in that the step of computing the potential active waypoint comprises the choice of the waypoint optimizing the computed predictions.

According to another feature of the method according to the invention, the predicted parameter is the time, the fuel, the speed and altitude along the flight plan.

According to another feature of the method according to the invention, the method applied by an FMS computer comprising a function called OFFSET, the method also comprises the following steps:
the computation of a distance XTK between the aircraft and the flight plan,
the computation of a rate of convergence dXTK of the aircraft towards the flight plan,
the automatic activation of the method when the OFFSET function is inactive and when at least one of the following conditions is verified:
   the distance XTK between the aircraft and the flight plan is less than a threshold D₁ and dXTK corresponds to a time for rejoining the flight plan that is less than a first rejoining time T₁,
   the aircraft follows a path that is parallel and in the direction of the flight plan for a time greater than a time threshold dT,
   the lateral navigation mode is set or activated and dXTK corresponds to a rejoining of the flight plan that is less than a second rejoining time T₂.

A further subject of the invention is a navigation aid device for an aircraft comprising means for applying the method according to the invention, the application means comprising means for displaying waypoints of a flight plan of the aircraft and predictions of the travelling time, the speed and altitude to the waypoints, the navigation aid device comprising:
means for displaying a potential active waypoint computed from a rejoining path and,
means for selecting the computed potential active waypoint.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a first example of an aircraft situated outside its flight plan and converging on the flight plan.

FIG. 2 represents a second example of an aircraft situated outside its flight plan and converging on the flight plan.

FIG. 3 represents a third example of an aircraft situated outside its flight plan and converging on the flight plan.

FIG. 4 represents a fourth example of an aircraft situated outside its flight plan.

FIG. 5 represents a fifth example of an aircraft situated outside its flight plan and converging on the flight plan.

FIG. 6 represents an aircraft on its flight plan.

FIG. 7 represents logic tree of the conditions for activation of the method according to the invention.

FIG. 8 shows an aircraft and its flight plan corresponding to a model of arrival by succession of directions.

FIG. 9 shows an example of use of a navigation aid device for an aircraft according to the invention.

### DETAILED DESCRIPTION OF THE INVENTION

The invention proposes a navigation aid method for an aircraft. The aircraft occupies a position PPOS outside its flight plan and seeks to rejoin its flight plan. The flight plan comprises a succession of waypoints, a waypoint WPTᵢ being called sequenced once the aircraft has passed by the waypoint WPTᵢ. The next unsequenced waypoint is called the active waypoint. The method according to the invention comprises the following steps:
the computation of at least one path to rejoin the flight plan from the current position PPOS,
the computation of a potential active waypoint in the flight plan based on a rejoining path,
the display of the potential active waypoint,
if the pilot confirms the potential active waypoint, the sequencing of the waypoints situated upstream of the potential active waypoint, the potential active waypoint becoming the new active waypoint,
if the pilot does not confirm the potential active waypoint, the return to the step for computing at least one rejoining path.

According to a first variant of the method according to the invention, the computation of at least one path for rejoining the flight plan from the current position PPOS consists in extrapolating the current path of the aircraft from its heading. In the first variant of the method according to the invention, the computation of a potential active waypoint in the flight plan based on the rejoining path consists in computing the intersection between the rejoining path and the flight plan. The potential active waypoint is the waypoint situated downstream of the intersection.

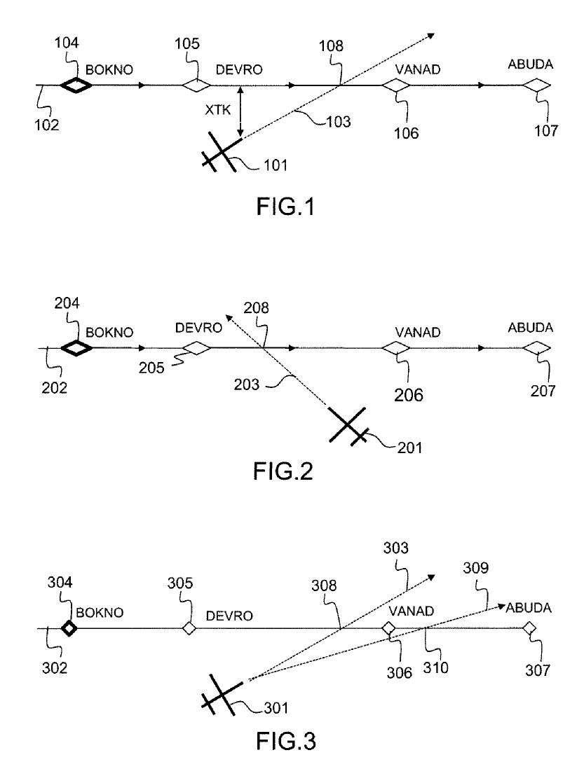

FIG. 1 represents a first example with an aircraft 101 situated outside its flight plan 102, following a path 103 and converging on its flight plan 102. The flight plan comprises four waypoints BOKNO 104, DEVRO 105, VANAD 106 and ABUDA 107. The aircraft is situated at a distance XTK from the flight plan. The distance XTK is computed according to an orthogonal projection on the flight plan 102. The active waypoint is the waypoint BOKNO 104. In this example, the potential active waypoint is the waypoint VANAD 106 situated downstream of the intersection 108.

FIG. 2 represents a second example with an aircraft 201 situated outside its flight plan 202, following a path 203 and converging on its flight plan 202. In the second example, the convergence occurs in the direction opposite to the progression of the flight plan. The flight plan comprises four waypoints BOKNO 204, DEVRO 205, VANAD 206 and ABUDA 207. The active waypoint is the waypoint BOKNO 204. As for the first example, the potential active waypoint is the waypoint situated downstream of the intersection 208 between the path 203 and the flight plan 202. In this example, it is the waypoint VANAD 206.

According to a feature of the first variant of the method according to the invention, the method also comprises a step of automatic recomputation of the potential active point when the aircraft changes heading.

FIG. 3 represents a third example with an aircraft 301 situated outside its flight plan 302, following a first path 303 and converging on its flight plan 302. The flight plan comprises four waypoints BOKNO 304, DEVRO 305, VANAD 306 and ABUDA 307. The active waypoint is the waypoint BOKNO 304. As for the first example, the potential active waypoint is the waypoint situated downstream of the intersection 308 between the first path and the flight plan. In this example, it is the waypoint VANAD 306. When there is a change of heading of the aircraft 301, the method according to the invention automatically recomputes a second path 309 and a second intersection 310 between the second path 309 and the flight plan 302. The method according to the invention also recomputes a new potential active waypoint. In this example, it is the point ABU DA 307.

A second variant of the method according to the invention is based on the combined evolution of several predictions, at least three, and their respective evolution. The advantage of the second variant is to propose an active waypoint optimizing the computed predictions.

According to the second variant of the method according to the invention, the step of computing at least one path comprises:
the selection of at least two unsequenced waypoints WPT₁ and WPT₂,
and, for each of these two waypoints:
   the computation of a path for rejoining the waypoint,
   the computation of predictions of at least one flight parameter.

The computation of the potential active waypoint consists in choosing the waypoint optimizing the computed predictions.

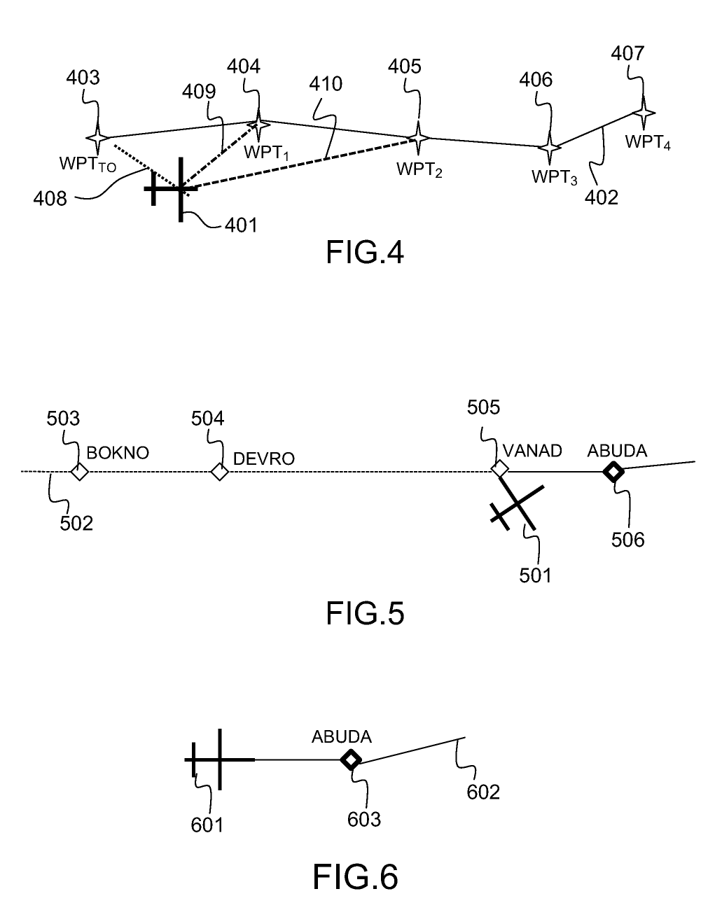

FIG. 4 represents a fourth example with an aircraft 401 situated outside its flight plan 402. The flight plan comprises five waypoints WPT_{TO} 403, WPT₁ 404, WPT₂ 405, WPT₃ 406 and WPT₄ 407. In this example, a first set of predictions PRED₁ is computed between PPOS and the arrival point by considering that the potential active waypoint is WPT₁, the aircraft then following a first path 409. A second set of predictions PRED₂ is computed between PPOS and the arrival point by considering that the potential active waypoint is WPT₂, the aircraft then following a second path 410. The method also uses a set of predictions PRED computed between PPOS and the arrival point by considering that the potential active waypoint is the actual active waypoint, the aircraft then following a third path 408.

The computation of the potential active waypoint consists in choosing the waypoint optimizing the computed predictions. The computation is based on an analysis of the variation of PRED, PRED₁ and PRED₂.

The truth table below makes it possible to establish an analysis methodology based in this instance on a prediction of the time of arrival at the destination airport, but any other parameter making it possible to characterize the progression of the aircraft relative to its flight plan can be used, and the coupling of several parameters. The table shown below is not comprehensive and is given as a nonlimiting example.

| Case | PRED | PRED₁ | PRED₂ | Potential active point |
|---|---|---|---|---|
| 1 | Increase | Reduction | Reduction | WPT₁ |
| 2 | Increase | Increase | Increase | Unmodified |
| 3 | Increase | Increase | Reduction | WPT₂ |
| 4 | Reduction | Increase | Increase | A WPT between the |
| | | | | TO and the WPT |
| | | | | serving as first |
| | | | | reference (FROM |
| | | | | waypoint, the point |
| | | | | preceding BOKNO in |
| | | | | FIGS. 1, 2 and 3) |

A first case corresponds to an increase of the prediction PRED considering that the potential active waypoint is the actual active waypoint and corresponds to a reduction of the predictions PRED₁ and PRED₂. The potential waypoint is then WPT₁.

A second case corresponds to an increase of the predictions PRED, PRED₁ and PRED₂. The rejoining point is not then modified. This case corresponds to being permanently distant from the path.

A third case corresponds to an increase of the predictions PRED and PRED₁ and to a reduction of the prediction PRED₂. This case corresponds to a passage through the waypoint WPT₁. The potential waypoint is then WPT₂.

A fourth case corresponds to a reduction of the prediction PRED and a reduction of the predictions PRED₁ and PRED₂. The potential waypoint is then a point between the active point and the waypoint serving as first reference (that is to say the last point that was sequenced, known as the ‘FROM waypoint’).

According to one feature of the invention, the prediction shown to the pilot is the prediction passing through the rejoining point proposed by the method (ABUDA in the example of FIG. 5; the prediction corresponds to the flight plan shown in FIG. 6 in this example). This allows the crew to have a prediction of the option that is presented to it and no longer to have a prediction that remains anchored on the last unsequenced active point.

The prediction is open-ended and allows the pilot, for example thanks to a display specifying the waypoint concerned, to help the crew to take a decision concerning its flight plan.

According to one feature of the invention, during the step of confirming the potential active point, the various displays, notably a navigation screen called “ND” and on the flight plan page or FPL of the MCDU/MFD, are updated to take account of the new active point. But the flight plan is not erased so long as the aircraft does not reach the flight plan (XTK close to 0), which makes it possible, in the case of readjustment of the heading, to again propose another sequencing point of the flight plan, a point situated before or after that initially selected while considering the selection of sequencing made beforehand by the pilot.

The sequenced portion of the flight plan is for example displayed in dotted lines or in a distinct colour in order to identify the portion that will be sequenced at the intersection of the flight plan and the aircraft's path.

FIG. 5 represents a fifth example of an aircraft 501 situated outside its flight plan 502 and converging on the flight plan 502. The active waypoint is the waypoint ABUDA 506. The portion of the flight plan upstream of the waypoint VANAD 505 comprising the waypoints BOKNO 502 and DEVRO 504 is displayed in dotted lines.

According to one feature of the invention, at the flight plan approach, the points upstream of the intersection are erased from the navigation screen displays and the FPL page of the MCDU.

FIG. 6 represents the aircraft 601 of the previous example having rejoined its flight plan 602 and heading towards the active point ABUDA 603. On the approach of the flight plan 602, the sequencing confirmed by the pilot at the waypoint VANAD, not shown, is taken into account on the navigation screen. The points upstream are erased from the navigation screen and from the FPL page of the MCDU/MFD.

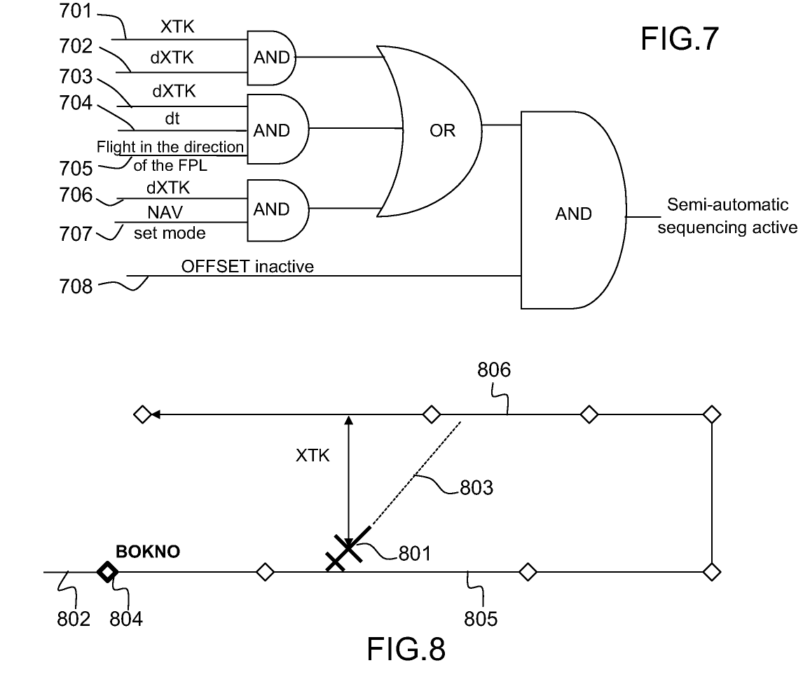

According to one feature of the invention, the navigation aid method also comprises the following steps:
the computation of a distance XTK between the aircraft and the flight plan,
the computation of a rate of convergence dXTK of the aircraft towards the flight plan,
the semi-automatic activation (that is to say confirmed by the pilot) of the method according to the invention in certain conditions. FIG. 7 represents a logic tree of the conditions for activating the method according to the invention. The method according to the invention is active when the OFFSET function is inactive 708 and when at least one of the following conditions is verified.
   The distance XTK between the aircraft and the flight plan is less than a threshold D₁ 701 and dXTK corresponds to a time for rejoining the flight plan that is less than a first rejoining time T₁ 702, it is possible to take for example a threshold of distance D₁ equal to 25 Nn and a rejoining time T₁ equal to 4 minutes. In the approach phase, the threshold of distance D₁ may be 15 Nm in order to eliminate the cases of unwanted sequencing. The value of the threshold D₁ in the climb, cruise and descent phase is usually greater than the value of the threshold D₁ in the take-off, approach and missed approach phase;
   The aircraft follows a path that is parallel and in the direction of the flight plan 705 for a time greater than a threshold of time dT 704, it is possible to consider that the path is parallel to the flight plan when dXTK is such that the path forms an angle of more than 5° with the flight plan 703; it is possible to take for example a threshold of time dT of 5 minutes.
   the lateral navigation mode is set or activated 707 and dXTK corresponds to a rejoining of the flight plan that is less than a second rejoining time T₂ 706, it is possible to take for example a second rejoining time T₂ equal to 8 minutes.

The advantage of this feature is that it does not disrupt the pilot with a display of a potential active waypoint when the pilot, considering the path and the flight plan, does not envisage sequencing. The purpose is that the pilot has a display when he needs one, neither too soon so as not to be visually disturbed, nor too late in order to take advantage of the semi-automatic function. The pilot may at any time continue to sequence the flight plan according to the usual methods.

The step of semi-automatic activation also comprises an additional condition:
the aircraft diverges from the closest section of the flight plan but converges on a flight plan section that is further away and the navigation mode following the flight plan is activated.

This situation may occur for example in the arrival model by succession of directions. FIG. 8 shows an aircraft 801 and its flight plan 802 corresponding to an arrival model by succession of directions. The flight plan comprises an active waypoint, the waypoint BOKNO 804. The aircraft follows a path 803. The aircraft diverges from the section 805 closest to the flight plan but converges on a more distant flight plan section 806.

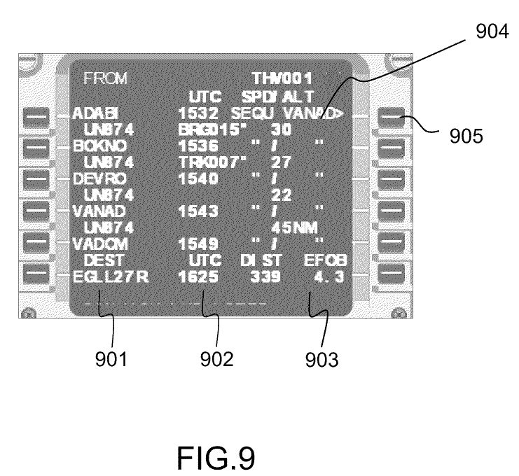

The invention also relates to a navigation aid device for an aircraft. FIG. 9 shows an example of using a navigation aid device for an aircraft according to the invention. Such a device comprises means 901 for displaying waypoints of a flight plan of the aircraft and predictions of the travelling time 902, the speed and the altitude 903 to the waypoints. The navigation aid device for an aircraft according to the invention also comprises means 904 for displaying a potential active waypoint computed according to the method according to the invention and means 905 for selecting the potential active waypoint, as necessary.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Navigation aid method for an aircraft, the aircraft occupying a position PPOS outside its flight plan and seeking to rejoin the flight plan, the flight plan comprising a succession of waypoints, a waypoint WPTᵢ being called sequenced once the aircraft has passed the waypoint WPTᵢ, the next unsequenced waypoint being called an active waypoint, said method comprising the following steps:
the computation of at least one path to rejoin the flight plan from the current position PPOS,
the computation of a potential active waypoint in the flight plan based on a rejoining path,
the display of the potential active waypoint,
if the pilot confirms the potential active waypoint, the sequencing of the waypoints situated upstream of the potential active waypoint, the potential active waypoint becoming the new active waypoint, and
if the pilot does not confirm the potential active waypoint, the return to the step for computing at least one rejoining path and the proposal of a new potential active waypoint.

2. The method according to claim 1, comprising a step of computing the intersection between the said path for rejoining the flight plan and the said flight plan and in that the computed potential active waypoint is the first waypoint situated downstream of the said intersection.

3. The method according to claim 1, wherein the step of computing at least one path for rejoining the flight plan comprises:
the selection of at least two unsequenced waypoints,
and, for each of these two waypoints:
the computation of a path for rejoining the said waypoint,
the computation of predictions of at least one flight parameter,
and in that the step of computing the potential active waypoint comprises the choice of the waypoint optimizing the computed predictions.

4. The method according to claim 3, wherein the predicted parameter is the time, the fuel, the speed and altitude along the flight plan.

5. The method according to claim 1, wherein said method is applied by an FMS computer comprising a function called OFFSET, said method also comprises the following steps:
the computation of a distance XTK between the aircraft and the flight plan,
the computation of a rate of convergence dXTK of the aircraft towards the flight plan,
the automatic activation of the method when the OFFSET function is inactive and when at least one of the following conditions is verified:
the distance XTK between the aircraft and the flight plan is less than a threshold D₁ and dXTK corresponds to a time for rejoining the flight plan that is less than a first rejoining time T₁,
the aircraft follows a path that is parallel and in the direction of the flight plan for a time greater than a time threshold dT, and
the lateral navigation mode is set or activated and dXTK corresponds to a rejoining of the flight plan that is less than a second rejoining time T₂.

6. A navigation aid device for an aircraft comprising means for applying the method according to claim 1, the application means comprising means for displaying waypoints of a flight plan of the aircraft and predictions of the travelling time, the speed and altitude to the waypoints, the said navigation aid device being wherein it also comprises:
means for displaying a potential active waypoint computed from a rejoining path and,
means for selecting the said computed potential active waypoint.

7. The method according to claim 6, comprising a step of computing the intersection between the said path for rejoining the flight plan and the said flight plan and in that the computed potential active waypoint is the first waypoint situated downstream of the said intersection.

8. The method according to claim 6, wherein the step of computing at least one path for rejoining the flight plan comprises:
the selection of at least two unsequenced waypoints,
and, for each of these two waypoints:
the computation of a path for rejoining the said waypoint,
the computation of predictions of at least one flight parameter,
and in that the step of computing the potential active waypoint comprises the choice of the waypoint optimizing the computed predictions.

9. The method according to claim 6, wherein the predicted parameter is the time, the fuel, the speed and altitude along the flight plan.

10. The method according to claim 6, wherein said method is applied by an FMS computer comprising a function called OFFSET, said method also comprises the following steps:
the computation of a distance XTK between the aircraft and the flight plan,
the computation of a rate of convergence dXTK of the aircraft towards the flight plan,
the automatic activation of the method when the OFFSET function is inactive and when at least one of the following conditions is verified:
the distance XTK between the aircraft and the flight plan is less than a threshold D₁ and dXTK corresponds to a time for rejoining the flight plan that is less than a first rejoining time T₁,
the aircraft follows a path that is parallel and in the direction of the flight plan for a time greater than a time threshold dT, and
the lateral navigation mode is set or activated and dXTK corresponds to a rejoining of the flight plan that is less than a second rejoining time T₂.

11. The method according to claim 7, wherein the step of computing at least one path for rejoining the flight plan comprises:
the selection of at least two unsequenced waypoints,
and, for each of these two waypoints:
the computation of a path for rejoining the said waypoint,
the computation of predictions of at least one flight parameter,
and in that the step of computing the potential active waypoint comprises the choice of the waypoint optimizing the computed predictions.

12. The method according to claim 8, wherein the predicted parameter is the time, the fuel, the speed and altitude along the flight plan.

13. The method according to claim 9, wherein said method is applied by an FMS computer comprising a function called OFFSET, said method also comprises the following steps:
the computation of a distance XTK between the aircraft and the flight plan,
the computation of a rate of convergence dXTK of the aircraft towards the flight plan,
the automatic activation of the method when the OFFSET function is inactive and when at least one of the following conditions is verified:
the distance XTK between the aircraft and the flight plan is less than a threshold D₁ and dXTK corresponds to a time for rejoining the flight plan that is less than a first rejoining time T₁,
the aircraft follows a path that is parallel and in the direction of the flight plan for a time greater than a time threshold dT, and
the lateral navigation mode is set or activated and dXTK corresponds to a rejoining of the flight plan that is less than a second rejoining time T₂.
